(19) United States
(12) Patent Application Publication
(10) Pub. No.: US 2008/0018651 A1
(43) Pub. Date: Jan. 24, 2008

(54) Method and system for capturing image frame

(76) Inventors: Wen-Juin Huang, Taipei (TW); Chung-Ching Huang, Taipei (TW); Hao-Lin Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/522,900

(22) Filed: Sep. 19, 2006

(30) Foreign Application Priority Data
Jul. 21, 2006 (TW) 095126850

(51) Int. Cl. G06F 15/00

(52) U.S. Cl. 345/501

(57) ABSTRACT

A method for capturing an image data from a frame buffer of a computer system takes advantage of a system management interrupt service optionally triggered. If a storage unit functions normally when the computer system fails to work normally, store the image data in the frame buffer into the storage unit. Otherwise, temporarily store the image data in a buffer unit, and then store it in a NVRAM. Then restart the storage unit and restore the image data in the buffer unit into the storage unit. At last, restart the computer system.

### FIELD OF THE INVENTION

The present invention relates to a method and system for capturing an image frame, and particularly to a method and system for capturing image data in a frame buffer utilizing system management interrupt.

### BACKGROUND OF THE INVENTION

For its facility and powerful functionality, computer systems have become necessities in living. As the popularity of computer systems increases, people rely on computer systems to handle with complex and sophisticated work more and more. This in turn brings the need of even more delicate computer systems to satisfy various requirements. However, complex functionality is accompanied with further complicated technology. Consideration should be taken on more and more things, but still not able to cover the whole thing. Under such circumstances, system designers have to analyze problem issues and its origin to provide solutions for error conditions. These solutions then are verified to make sure problems have been solved well. Furthermore, test reports of verification can be useful references for upgrading to avoid same errors happening again.

Despite all the efforts have done, problems may still happen in unexpected ways. When the computer system is on the market, system designers will receive error feedback from common users, who might not know the computer system well. In general, users may report an error feedback by phone or e-mail to provide information. But this is not a convenient way to common users, since they don't know enough about the situation, and in turn requires more time on exchanging information and verifying the error problems. As a result, a mechanism is needed to provide common users an easy way to record error messages shown by the computer systems or other information.

### SUMMARY OF THE INVENTION

Therefore, the present invention provides a method of screen capturing method for capturing the image data utilizing the system management interrupt. The method includes determining whether the image data in a frame buffer can be stored in a store unit; if yes, store the image data in the store unit; if not, store the image data in a buffer unit. Then a mark is generated corresponding to the system management interrupt service and is stored in a non-violate random access memory. After that restart the store unit and execute the system management service, i.e. store the image data in buffer unit into the store unit. When the system management service is done, clear the mark and restart the computer system.

### BRIEF DESCRIPTION OF THE DRAWINGS

FIG. 1 is block diagram of an image frame capturing system according to a preferred embodiment of the present invention.

FIG. 2 is a flow chart of an image frame capturing method according to a preferred embodiment of the present invention.

### DETAILED DESCRIPTION OF THE INVENTION

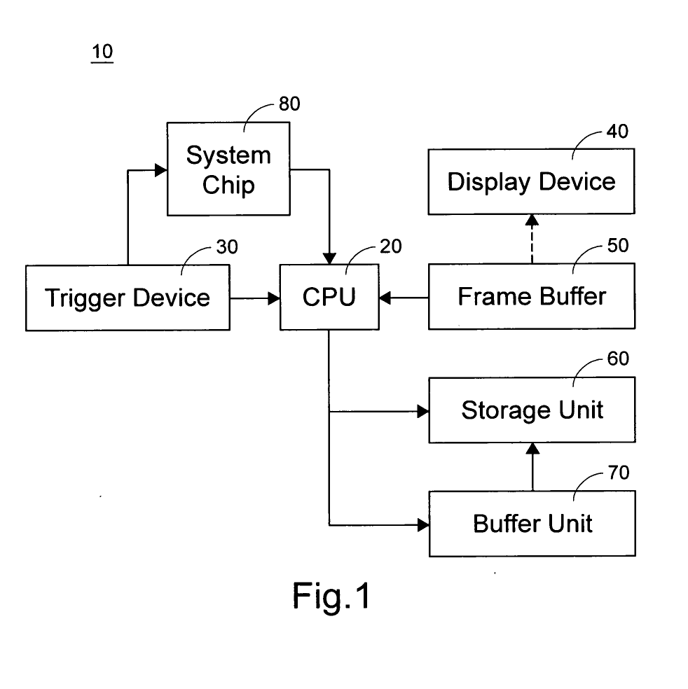

First refer to FIG. 1, which depicts a block diagram of an image frame capturing system according to a preferred embodiment of the present invention. The image frame capturing system 10 includes a CPU 20, a trigger device 30, a display device 40, a frame buffer 50, a storage unit 60 and a buffer unit 70. The trigger device 30 is configured to trigger a system management interrupt (SMI), which drives the CPU to execute a SMI service of capturing the image data in the frame buffer 50. The storage unit 60 is configured to store the captured image data from the frame buffer 50. If the storage unit 60 is unable to store the image data temporarily, the CPU 20 will store it in the buffer unit 70 first and later restore the image data into the storage unit 60 after the storage unit 60 is available or restarted.

When the computer system works in normal, the image data in the frame buffer 50 is outputted to the display device 40. The display device 40 offers an interface for the users to control the computer system, such as clicking certain window shown thereon by a mouse. Once the computer system encounters an error, the operating system might fail to function. The image data in the frame buffer 50 will not be refreshed and the user is unable to control the computer system via the mouse or other I/O devices. Therefore, the user is unable to save the error message shown on the display device 40 by I/O devices.

To overcome the above described problems, the present invention provides an image capturing system 10, in which the CPU 20 is driven to enter a system management mode (SMM) for executing a SMI service by a trigger device 30. In this manner, the image data in the frame buffer 50 can be reserved even if the operating system has failed. The trigger device 30 can be disposed as a button at a general purpose input output (GPIO) port. Once the user presses this button, a trigger signal is sent to a system chip 80, for example a south bridge chip. The south bridge chip then sends a SMI signal to the CPU 20 according to the trigger signal. The CPU 20 then enters the SMM in response to the SMI signal to execute the SMI service of capturing the image data in the frame buffer 50. After entering SMM, the CPU 20 is released from the operating system and controlled by the basic input output system (BIOS). Therefore, the computer system may reserve the image data in the frame buffer 50 by executing the SMI service.

While executing the SMI service, the CPU 20 captures the image data in the frame buffer 50 and stores the image data in the storage unit 60 by a predefined filename. The storage unit 60 can be predefined as a hard disk for example. If the storage unit 60 is not available for accessing any data due to the failure of the operating system, the CPU 20 may store the image data in one or more buffer units 70 temporarily. Such a buffer unit 70 may be a non-volatile random access memory (NVRAM) or a flash memory. As the buffer unit 70 is designed to store system parameters and does not reserve data permanently, the CPU 20 needs to restart the storage unit 60 soon to recover normal access. Then the CPU 20 restores the image data in the buffer unit 70 into the storage unit 60 with the predefined filename when the storage unit 60 is able to be accessed. After the SMI service is completed, the computer system is restarted. Then the user may find the image data file which contains error message in the storage unit 60 with the predefined filename, and send the file to the designer by email or other communication tools.

In addition, the CPU 20 adds a header or footer to the image data stored in an amount of buffer units 70. This can be beneficial to the CPU 20 for finding the image data separated in many buffer units 70 by the header or footer and restoring it to the storage unit 60 more quickly. Furthermore, the CPU 20 generates a mark corresponding to the SMI service and stores it in the buffer unit 70. The image data and the mark may be stored in the same buffer unit 70, if necessary. If the mark is detected while booting, the computer system will restart the storage unit 60 first and restore the image data from the buffer unit 70 to the storage unit 60. In this manner, the image data can be saved before being flushed. If the image data has been successfully stored in the storage unit 60, the CPU 20 then clears the mark corresponding to the SMI service. Next time the computer system is booted, the SMI service can be skipped for the mark is cleared.

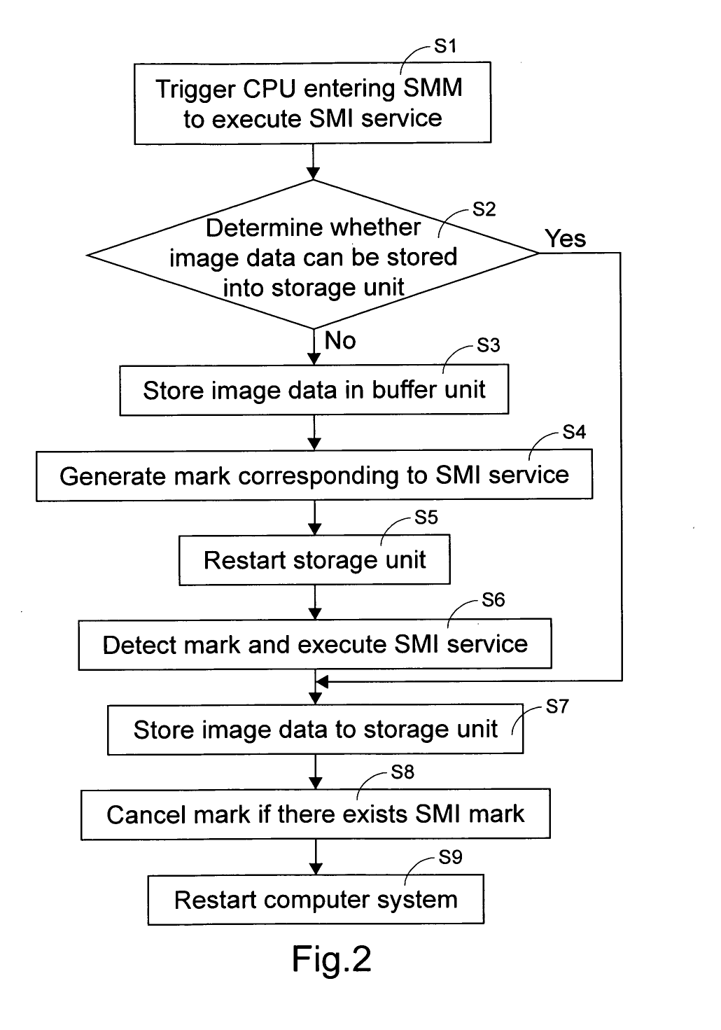

Please refer to FIG. 2 combining with FIG. 1. As shown in FIG. 2, a flow chart of an image frame capturing method is illustrated according to an embodiment of the present invention. First in step S1, the CPU 20 enters a SMM triggered by a trigger device 30 to execute a SMI service for capturing image data stored in a frame buffer 50. The trigger device 30 can be disposed as a button at a GPIO port, for example. When the computer system is subject to data access error and the display device 40 becomes idle, a trigger signal is outputted by pressing the button and sent to a system chip 80, such as a south bridge chip, in the computer. Then the system chip sends a SMI signal to the CPU 20 in the computer system. Corresponding to the SMI signal, the CPU 20 enters the SMM for executing a SMI service to capture the image data in the frame buffer 50. Therefore, the image data can be captured by triggering the SMI signal utilizing the trigger device 30 when error happens.

Next in step S2, whether the image data captured from the frame buffer 50 can be stored into the storage unit 60 is determined. The failure of the computer system does not result in ineffectiveness of the storage unit 60 in all situations. In the case that the storage unit 60 still works normally, the image data captured from the frame buffer 50 is stored into the storage unit 60. The storage unit 60 can be, for example, a hard disk. The storage unit 60 is predefined for storing the image data with a predefined filename.

In most cases, failure of the computer system results in the failure of the storage unit 60. In such a situation, the image data is temporarily stored in a buffer unit 70, as indicated by step S3. The buffer unit 70 can be a non-volatile random access memory (NVRAM) provided to prevent the image data from loss due to off power. The buffer unit 70 can also be a flash memory, which has the capacity of at least a million bytes.

In addition, a header or a footer is added to the image data temporarily stored in the buffer unit 70. If the image data is stored in more than one buffer unit 70, the header or the footer can facilitate the search of the image files scattering in those buffer units 70.

In step S4, a SMI mark is generated corresponding to the SMI service for capturing image frame data. The SMI mark is stored in a NVRAM when the computer system is out of power. The SMI mask functions to remind the computer system of the presence of the image data in the buffer unit 70 to be transferred to the storage unit. In this manner, the image data temporarily stored in the buffer unit 70 will be able to be restored before any other access to the buffer unit 70 is executed. The image data and the SMI mark are stored in a similar way and can be stored in the same one or more buffer units 70.

To permanently reserve the image data, the computer system restarts the storage unit 60 and executes the SMI service indicated by the mask to transfer the image data from the buffer unit(s) 70 to the storage unit 60 in step S5 and step S6. As described above, the buffer unit(s) 70 is configured to temporarily store system parameters of the computer system and cannot reserve data in the long term. Therefore, the storage unit 60 has to be restarted for storing the image data.

When the storage unit 60 is restarted and the SMI service corresponding to the SMI mark is performed in step S6, the image data stored in the buffer unit 70 is first kept from being cleared. The image data in the buffer unit 70, such as NVRAM, is possible to be overwritten by the computer system while booting or restarting. Therefore, the image data should be protected before being restored in the storage unit 60. Subsequently, the image data is restored in the predefined storage unit 60, for example a hard disk, with a predefined filename (step S7). Subsequently, the user may find the image data file according to the predefined filename and attaches it to an email to report the error condition. The last thing to do is to clear the SMI mark corresponding to the SMI service (step S8). The image data or the SMI mark in the buffer unit 70 may affect the system performance, such as the storage of system parameters, and thus needs to be cleared. Please note that after restarting the storage unit 60 in step S5, the computer system is forced to go to step S6 if a SMI mark is detected. In this manner, the captured data can be properly reserved in the storage unit 60 and the process will not be interrupted by other SMI services or commands.

Finally in step S9, the computer system is restarted to recover the operating system. The buffer unit 70 is able to store system parameters after the SMI mark is cleared in step S6. Consequently, the computer system can be restarted in a normal procedure. In addition, if the image data captured from the frame buffer 50 is directly stored in the storage unit 60, the computer system directly goes to step S9 to restart. After above steps are completed, the user may find the image data based on the predefined filename, and provide it to the system designer by email or other ways. In this manner, the system designer may obtain detailed and precise information.

Concluded from the above description, the present invention provides an image frame capturing method that captures image data by executing a SMI service. The method includes determining whether the store unit is able to store image data from the frame buffer into the storage unit. If yes, store the image data in the storage unit and restart the computer system. If not, temporarily store the image data in the buffer unit. Then generate a SMI mark corresponding to the SMI service and store in a buffer unit. Subsequently restart the storage unit and move the image data from the buffer unit to the storage unit responding to the SMI mark. Once the image data is well reserved, clear the SMI mark and restart the computer system.

The present invention provides an efficient way to reserve error message when the computer system fails. System designers are benefited to obtain correct information for modification. Also the user is benefited to reserve valuable data when error happens.

While the present invention has been described in terms of what is presently considered to be the most practical and preferred embodiments, it is to be understood that the present invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for capturing an image data generated by a computer system, the method comprising:
generating a system management interrupt signal in response to a trigger operation for capturing said image data;
entering said computer system into a system management mode in response to said system management interrupt signal;
storing said image data when said computer system enters said system management mode; and
restarting said computer system to access said image data previously stored.

2. The method according to claim 1, wherein said trigger operation is performed by pushing a button at a general purpose input output port of said computer system when an operating system of said computer system fails to work normally.

3. The method according to claim 1, wherein said system management interrupt signal is generated by a south bridge chip of said computer system.

4. The method according to claim 1, wherein said image data is an image frame data stored in a frame buffer of said computer system and is to be restored into a storage unit when said computer system enters said system management mode.

5. The method according to claim 4, wherein said image data is stored into a buffer unit of said computer system before being restored into said storage unit when said storage unit fails to work normally upon said computer system is entering said system management mode.

6. The method according to claim 5, further comprising:
generating a SMI mark indicating that said image data is stored into said buffer unit;
restarting said storage unit;
restoring said image data from said buffer unit into said storage unit when said SMI mark is detected; and
clearing said SMI mark after said image data is stored into said storage unit.

7. The method according to claim 6, wherein said SMI mark is generated in response to said system management interrupt signal and stored in said buffer unit.

8. The method according to claim 5, further comprising:
adding a header or a footer to said image data stored in said buffer unit.

9. The method according to claim 5, wherein said buffer unit is a non-volatile random access memory or a flash memory.

10. The method according to claim 1, wherein said storage unit is a hard disk.

11. A method for capturing an image frame data generated by a computer system, comprising:
generating a system management interrupt signal in response to a trigger operation for capturing said image frame data;
entering said computer system into a system management mode in response to said system management interrupt signal;
storing an image frame data in a frame buffer into a buffer unit when said computer system enters said system management mode; and
storing said image frame data in said buffer unit into a storage unit.

12. The method according to claim 11, further comprising adding a header or a footer to said image frame data when said image frame data is stored into said buffer unit.

13. The method according to claim 11, wherein said image frame data is stored into said storage unit with a predefined filename.

14. The method according to claim 11, further comprising:
restarting said storage unit before said image frame data is stored into said storage unit; and
restarting said computer system after said image frame data is stored into said storage unit.

15. The method according to claim 11, further comprising:
storing a SMI mark in said buffer unit before said image frame data is stored into said storage unit; and
canceling said SMI mark from said buffer unit after said image frame data is stored into said storage unit.

16. A system for capturing an image frame data generated by a computer system, comprising:
said computer system;
a trigger device coupled to said computer system and optionally actuated for interrupting said computer system to capture said image frame data from a frame buffer of said computer system; and
a storage unit coupled to said computer system to store said image frame data in said frame buffer.

17. The system according to claim 16, wherein a system management interrupt signal is issued from a system chip to a CPU of said computer system when said trigger device is actuated, thereby having said CPU enter a system management mode for executing a system management interrupt service of capturing said image frame data from said frame buffer.

18. The system according to claim 16, further comprising at least one buffer unit for temporarily storing said image frame data when said storage unit is unable to be accessed.

19. The system according to claim 18, wherein said computer system generates a mark corresponding to said image frame data temporarily stored in said buffer unit, and clears said mark after said image frame data is stored in said storage unit.

20. The system according to claim 18, wherein said computer system adds a header or a footer to said image frame data stored in said buffer unit and gives a predefined filename to said image frame data stored in said storage unit.

21. The system according to claim 18, wherein said buffer unit is a non-volatile random access memory or a flash memory.

22. The system according to claim 16, wherein said trigger device a button disposed at a GPIO port.

23. The system according to claim 16, wherein said storage unit is a hard disk.
